(19) United States
(12) Patent Application Publication
(10) Pub. No.: US 2014/0121138 A1
(43) Pub. Date: May 1, 2014

(54) PROCESS FOR REMOVAL OF ZINC, IRON AND NICKEL FROM SPENT COMPLETION BRINES AND PRODUCED WATER

(71) Applicant: BAKER HUGHES INCORPORATED, Houston, TX (US)

(72) Inventors: Daniel P. Vollmer, Lafayette, LA (US); Jonathan J. Brege, Spring, TX (US); Paul H. Javora, Spring, TX (US)

(73) Assignee: BAKER HUGHES INCORPORATED, Houston, TX (US)

(21) Appl. No.: 14/063,188

(22) Filed: Oct. 25, 2013

Related U.S. Application Data
(60) Provisional application No. 61/720,025, filed on Oct. 30, 2012.

(51) Int. Cl. C09K 8/84; C22B 3/00

(52) U.S. Cl. CPC C09K 8/845; C22B 19/26; C22B 23/0461
USPC 507/269; 423/101; 423/143

(57) ABSTRACT

Zinc, nickel and iron can be recovered from spent brines and produced water using a method that includes admixing an aqueous fluid with hydrazine to form a hydrazine complex and then filtering or otherwise removing the hydrazine complex from the aqueous fluid. Once treated, the aqueous fluid can then be recycled or at be the subject to an easier disposal. The isolated metal hydrazine complex may be recycled or discarded.

### CROSS-REFERENCE TO RELATED APPLICATIONS

This application claims priority from U.S. Provisional Application 61/720,025, filed Oct. 30, 2012, the disclosure of which is incorporated herein by reference.

### BACKGROUND OF THE APPLICATION

1. Field of the Invention

This invention relates to recovery and regeneration of oilfield brines. This invention particularly relates to the recovery of and regeneration of oilfield brines by recovering metals therefrom.

2. Background of the Prior Art

In the art of searching for and producing oil and gas the term “brine” is used to describe fluids which are generally solutions of salt and/or salt mixtures. Depending upon which use to which the brine will be applied, the brine may be a solution of sodium chloride, sodium bromide calcium chloride, calcium bromide, and the like.

One such brine useful for well completions and work over operations is a brine prepared using zinc bromide. This brine has the advantage of being very heavy, if desired, with a potential density of about 20 pounds per gallon (2.4 kg/L) while at same time being solids free.

Unfortunately, zinc is regulated and is not subject to easy disposal. Disposal of fluids including zinc can be especially difficult at offshore oil and gas production facilities. Nickel is another metal which is regulated and not subject to easy disposal.

The term “produced water” means the aqueous fluids produced along with crude oil and natural gas. These fluids include the naturally present water in oil and gas bearing geological formations, and also include aqueous fluids introduced into such a formation during the process of recovering the oil and gas.

### SUMMARY OF THE INVENTION

In one aspect, the invention is a method of recovering zinc metal, nickel metal, iron metal, zinc cations, nickel cations or iron cations from fluids produced from an oil well, the method including admixing an aqueous fluid with hydrazine under conditions sufficient to produce an insoluble zinc or nickel hydrazine complex and removing the insoluble zinc or nickel hydrazine complex from the fluid.

In another aspect, the invention is a method as described above but further including recycling the treated fluids and or the insoluble zinc or nickel hydrazine complex.

In still another aspect, the invention is a method of recovering zinc metal, nickel metal, iron metal, zinc cations, nickel cations or iron cations from fluids produced from an oil well, the method including admixing an aqueous fluid with hydrazine under conditions sufficient to produce an insoluble zinc hydrazine complex and removing the insoluble zinc hydrazine complex from the fluid and then recycling the recovered zinc.

Another aspect of the invention is a method for removing zinc metal and/or zinc cations from fluids produced from an oil well, the method including: admixing a portion of an aqueous fluid produced from an oil well with a non-hydrazine complexing agent under conditions sufficient to produce an insoluble zinc complex; evaluating the results of the admixing for formation of a readily removable zinc complex; upon making a determination that the insoluble zinc complex has formed and is readily removable from the fluid, admixing some or all of the remaining aqueous fluid with the non-hydrazine complex under conditions sufficient to produce an insoluble zinc complex; and removing the insoluble zinc complex from the aqueous fluid.

In still another aspect, the invention is a method for rehabilitating an aqueous fluid intended for use downhole including admixing an aqueous fluid with hydrazine under conditions sufficient to produce an insoluble zinc hydrazine complex and removing the insoluble zinc hydrazine complex from the fluid; wherein the aqueous fluid is intended for use downhole in an oil well and the aqueous fluid has been contaminated with zinc.

Another aspect of the invention is a method for rehabilitating an aqueous fluid intended for use downhole, the method including: admixing a portion of an aqueous fluid intended for use downhole in an oil well with a non-hydrazine complexing agent under conditions sufficient to produce an insoluble zinc complex; evaluating the results of the admixing for formation of a readily removable zinc complex; upon making a determination that the insoluble zinc complex has formed and is readily removable from the fluid, admixing some or all of the remaining aqueous fluid with the non-hydrazine complex under conditions sufficient to produce an insoluble zinc complex; and removing the insoluble zinc complex from the aqueous fluid; wherein the aqueous fluid is intended for use downhole in an oil well and the aqueous fluid has been contaminated with zinc.

### DETAILED DESCRIPTION OF THE INVENTION

In one embodiment, the method of the application is a method of recovering zinc metal or zinc cations from fluids produced from an oil well, the method including admixing an aqueous fluid with hydrazine under conditions sufficient to produce an insoluble zinc hydrazine complex and removing the insoluble zinc hydrazine complex from the fluid.

The term “oil well” means a well or a system including a well used to produce crude oil or natural gas, including such wells that are used to recover oil or natural gas from coal seams. The term “fluids produced from an oil well” means any aqueous fluid recovered directly from an oil well or recovered indirectly from an oil well as the continuous or non-continuous phase of an admixture of aqueous and non-aqueous fluids. The term “aqueous fluid” means a fluid having a continuous phase of water.

In the method of the application, zinc or zinc cations are recovered from an aqueous fluid by admixing the aqueous fluid with a solution of hydrazine (H₂N—NH₂). Hydrazine in its pure form is a dangerous liquid. It is unstable and is used as a component in rocket fuels. Therefore, in most embodiments of the method of the disclosure, hydrazine is employed as an aqueous solution having a hydrazine concentration of from about 10% to about 50%. In some embodiments, the concentration is from about 20% to about 40%. And in one such embodiment, the concentration is about 35%.

Any method known to be useful to those of ordinary skill in the art of combining two fluids may be employed with the method of the disclosure. For example, in one embodiment, two fluid streams, a first fluid stream being an aqueous stream having a zinc concentration at an undesirable level; and a second fluid stream being a solution having a hydrazine concentration of about 35%; may be concurrently pumped through a pipe having a static mixer. In another embodiment, the two fluid streams may be introduced into a vessel having a stirring device. In yet another embodiment, the two fluids may be introduced into a portable vessel such as a tank car or a ship's hold and the motion resulting from the transportation of the fluid being used to admixed the fluids.

The molar ratios of hydrazine to zinc necessary to form an insoluble complex is from about one to about two moles of hydrazine to about one mole of zinc. While not wishing to be bound by any theory, it is never the less believe that the insoluble complex is a complex of hydrazine and zinc bromide and/or zinc chloride. Due to its comparatively low cost, it may be desirable to use an excess of hydrazine when treating an aqueous fluid. For example, in some embodiments, it may be desirable to use from about 2.0 to about 3.0 moles of hydrazine for each mole of zinc present in the zinc bearing fluid to be treated. Where it is not necessary to remove all of the zinc, less hydrazine may be employed.

Once the two fluid streams have been admixed, and an insoluble complex formed, then the insoluble complex is removed using any method known to be useful to those of ordinary skill in the art. For example, in one embodiment of the method of the disclosure, the zinc bromide and hydrazine complex may be filtered where the resulting filtrate may be substantially free of zinc. In another embodiment of the method of disclosure the insoluble complex may be isolated from the aqueous fluid employing a centrifuge. In still another embodiment of the method of the disclosure, especially one where there is no urgency, it may be desirable to allow the insoluble zinc hydrazine complex to settle out of the aqueous fluid.

In any of the prior described methods of removing the insoluble zinc hydrazine complex from the aqueous fluid, it may be desirable to employ additives to assist in the separation of the solids from the fluid that is a process called flocculation/coagulation. Suitable additives for this may be selected from the group consisting of nonionic, cationic, and anionic polymers. Other common additives like lime, alum and ferric sulfate can also be employed. Sodium hydroxide may be used. While these processes may be employed simultaneously with adding the complexing agent, in some embodiments, it will be desirable to first flocculate or coagulate as much of the zinc or nickel, and then treat with the complexing agent.

In some applications of the method of the disclosure, especially those that are performed on an offshore production platform, the zinc free aqueous fluid may be disposed by pumping it into the surrounding water. Onshore, in otherwise similar applications, the disposal may be performed by evaporation or disposal downhole. While in some embodiments of the method of disclosure it may be desirable to dispose of the aqueous stream once the zinc has been removed, in others it may be desirable to recycle the aqueous fluid into a new brine.

In some embodiments of the method of the disclosure, the insoluble zinc hydrazine complex may be disposed of directly, or recycled. Where it is the intent of a user of the method of the disclosure to recycle the zinc, the recycling may be done in any way known to be useful to those of ordinary skill in the art. For example, the zinc hydrazine complex can be treated with a peroxide to produce a zinc salt, such as zinc bromide. The resultant zinc bromide can then be used to generate a new zinc bromide brine.

Nickel is another controlled metal used in oil well fluids. Similar to zinc, nickel's most common oxidation state is +2, but it may be sometimes be found in other oxidations states, primarily +4. That being said, for the purposes of this disclosure, nickel may be removed from fluids produced from an oil well substantially similarly to zinc.

Iron is another metal that may be present at undesirable levels, especially in spent brines. Its most common oxidation states are +2 and +3. For the purposes of this disclosure, iron may be removed from fluids produced from an oil well also substantially similarly to zinc.

In addition to hydrazine, other complexing agents may be used. For example, a completion brine that is contaminated with zinc is mixed with a monodentate, bidentate, or poly dentate amine compound. One example of a bidentate complexing agent is ethylenediamine. Upon mixing, the amine preferentially binds to zinc forming an insoluble complex.

The physical characteristics of the insoluble complex will determine if it can be easily removed from solution which will depend on the complexing amine. The brine is then filtered, or centrifuged and the insoluble zinc/amine complex is removed from solution. In this case, the complex formed would be Zn(en)xBry Clz, where x, y, z are 0-2. The concentration of zinc in the recovered brine is now low enough that it can be considered to be free of zinc.

Complexing compounds useful with the invention include, but are not limited to: ethylenediamine (EDA), diethylenetriamine (DETA), trithethylenetetramine (TETA), tetraethylenepentamine (TEPA), Aminoethylethanolamine (AEEA), diethanol amine (DEA), diethyl amine, hexamethyltetraamine, monoethyl amine, poly amines, and the like. The specific monodentate amine complexes, bidentate complexes, and polydentate amine compounds are selected such they form insoluble species with zinc. Other compounds useful as complexing agents include, but are not limited to amino-ether, amino-alcohol, and amino-ketone analogs. Still other complexing agents include, but are not limited to phosphorus analogs.

The complexing agents are evaluated based upon their ability to preferentially bind to zinc forming insoluble complexes. Also, the complexing agents are evaluated for the ease with which they can be removed from solution. For example, if a complexing agent forms an insoluble precipitate but the precipitate formed is so small in size scalable filtering it is not possible, it would not be selected for use. For the purposes of the present application, the term “readily removable” means that the zinc complex is both insoluble and can be removed economically as compared to other means of zinc reduction available to treat the subject aqueous solution.

In another embodiment, the non-hydrazine complexing compound may be immobilized onto a substrate. Preferentially binding to zinc now allows a more efficient removal of the zinc/amine complex. The substrate may include nanoparticles, zeolites, polymer chains, solid substrates, or nanotubes. The collected insoluble zinc complex is considered waste and can be disposed. In different version of the invention, the collected zinc complex is treated to form soluble zinc which can be reused. The zinc complex may be treated with an acid, peroxide, or other oxidizing agent.

The method employing nonhydrazine complexing agents may also be employed using flocculation/coagulation as discussed hereinabove.

In addition to treating spent brines and other produced fluids, the methods of the disclosure can be used to rehabilitate contaminated brines. For example, brines can be contaminated during production by formulation error, or sometimes even by merely exposing the brines to new equipment that has been treated with zinc containing compounds. In those cases, the contaminated brine can be treated by the methods of the disclosure and thereby rehabilitated for use downhole.

### EXAMPLES

The following examples are provided to illustrate the present invention. The examples are not intended to limit the scope of the present invention and they should not be so interpreted. Amounts are in w/v parts or w/v percentages unless otherwise indicated

### Example 1

512 grams of a 12.3 ppg CaBr₂/CaCl₂ with 1.64% zinc (specific gravity=1.476 at 73.4° F.) were admixed with 18 ml of 55% hydrazine hydrate (35% hydrazine). Immediately, white solids formed and the brine was filtered through coarse diatomaceous earth. The percent zinc in the brine was titrated to contain 0% zinc and 472 grams of filtrate was recovered having a specific gravity of 1.466@69.2° F. The percent recovery was 92%.

### Example 2

To determine the likely composition of the insoluble zinc hydrazine complex, 806.600 grams of 19.2 ppg CaBr₂/ZnBr₂ containing 16.33% zinc and 9.454 grams of 55% hydrazine hydrate (35% hydrazine) were admixed. The limiting reagent is hydrazine and the excess is zinc bromide. White solids immediately formed and the mixture was filtered through coarse diatomaceous earth. The filtrate contained 20 ppm of hydrazine (determined by using a hydrazine test kit) and the zinc was reduced to 15.9%. Note that 4,054 ppm of hydrazine was added to the brine. Therefore, the hydrazine precipitated along with the zinc or escaped into the atmosphere. The solids were rinsed with deionized water and dried in a 120° F. oven for four days. Analytical analysis showed that the solids to be Zn(N₂H₄)₂Br₂, which indicates the hydrazine precipitated with the zinc. By performing a mass balance it was determined that 1 mole of zinc interacts with 2 moles of hydrazine in forming the zinc hydrate complex.

### Example 3

The solids produced in example 2 were added to DI water at 1% by weight. The mixture was shaken for several minutes and the solids did not appear to dissolve. The mixture was allowed to be quiescent for 24 hours and no change in solubility was noticed. The solids produced in Example 2 were added to 35% hydrogen peroxide at 10% by weight. The mixture released a gas and within 24 hours the solids completely dissolved. This Example shows that the precipitate can be dissolved and recycled into zinc brine.

### Example 4

A sample of produced water obtained from a well in the Gulf of Mexico was mixed with a 16.1 ppg zinc bromide/calcium bromide/calcium chloride brine at a ratio of about 75% produced water and 25% 16.1 ppg to simulate a completion brine mixed with produced water flowing out of a producing well. The Table below shows the percent calcium and zinc in the mixture. Two samples were prepared by admixing 450.4 grams of the produced water and brine mixture and 35% hydrazine was added to one of the samples while 30% sodium hydroxide was added to the other until the pH of both samples were above 7. Both samples were filtered through coarse diatomaceous earth and the filtrate analyzes. The Results are shown below in the table. Both the hydrazine and the sodium hydroxide solutions removed nearly all of the zinc but 55% more solids precipitated using the sodium hydroxide solution. The precipitated solids probably contained a mixture of calcium hydroxide, magnesium hydroxide, and zinc oxyhalide whereas the solids from the hydrazine mixture contain essentially zinc hydrazine halide. Note that the percent calcium decreased in the sodium hydroxide addition mixture indicating that calcium precipitated. Also note that the calcium concentration increased in the hydrazine addition mixture due to only the zinc precipitated thus increasing the percent calcium in the filtrate.

TABLE

| | | Produced Fluid + | Produced Fluid + |
|---|---|---|---|
| | Produced Fluid | 35% N₂H₄ | 30% NaOH |
| Calcium | 3.53% | 3.70% | 3.43% |
| Zinc | 4.35% | 0.0042%¹ | 0.00018%¹ |
| Iron | 11 ppm | 0 ppm | |
| Specific Gravity | 1.290 at 81.2° F. | 1.177 @ 72.9° F. | 1.228 @ 73.1° F. |
| Initial amount of | | 450.4 g | 450.4 g |
| produced fluid | | | |
| Amount added | | 51.3 grams 35% | 78.7 grams of 30% |
| | | N₂H₄ | NaOH |
| pH | 4.7 | 8.2 | 9.1² |
| Precipitant | | 141.8 grams | 220.5 grams |

¹Measured by ICP
²The pH was 7.2 when 76.973 grams of 30% NaOH was added.

### Example 5

To determine the effect of pH and filter media size, hydrazine hydrate was added to the identical simulated produced fluid described in Example 4 until the pH was 9.0. The amount added was 255 grams of the produce brine and 33.5 grams of the hydrazine hydrate added to the produced brine. A white precipitate formed immediately and at 1 hour the mixture was filtered through coarse diatomaceous earth. Then part of the filtrate was filtered through a finer filtration media size (fine diatomaceous earth). Both filtrates were measured for the zinc concentration using ICP (inductively coupled plasma spectrometry). The coarse diatomaceous earth filtrate had a 6.5 ppm (0.00065%) zinc concentration while the fine diatomaceous earth filtrate had a 1.9 ppm (0.00019%) zinc concentration. Note that by adjusting the pH near that of the sodium hydroxide addition in Example 4 nearly the same amount of zinc can be removed (1.9 ppm compared to 1.8 ppm in Example 4). Apparently, the hydrazine precipitant produces a fine particle that requires a finer filter media to effectively remove it.

### Comparative Example 6

Calcium hydroxide (lime) was added to 13.3 ppg containing 1.19% zinc, 3.8% chlorides and 32.9% bromide at 6 ppb while stirring. The 13.3 ppg had a pH of 6.0. The mixture was stirred for several hours and allowed to remain quiescent for 24 hours. Not all of the lime appeared to have dissolved. The mixture was filtered through coarse diatomaceous earth and the zinc was measured to be 0.73%. The pH of the filtrate was 6.5 and the lime only increased the pH by 0.5. The percent recovery was 84%. Not only did the lime fail to remove most of the zinc but the percent recovery was only 84%.

### Example 7

Seven ml of Hydrazine (35%) was added to 511.585 grams of 12.3 ppg brine calcium chloride/calcium bromide brine that was contaminated with 1.64% zinc at the rig. The brine contained 15.6% bromide and 15.6% chlorides. The pH increased from a 6.2 to 6.8. The fluid was filtered through coarse diatomaceous earth and the zinc and hydrazine concentration was measured to be 0.32% and 50 ppm, respectively. The percent recovery was 92% and the density only deceased by 0.1 ppg. The test was repeated with 18 ml of hydrazine and no zinc could be detected by titration but the hydrazine concentration was above 50 ppm.

### Example 8

An 11.0 ppg CaCl₂ solution having a pH of 5.0 was prepared by diluting an 11.6 ppg CaCl₂ with water. While mixing with an overhead stirrer, 1.6317 grams of nickel chloride hexahydrate (NiCl₂,6H₂O) was added to 499.1 grams of 11.0 ppg CaCl₂. The nickel chloride hexahydrate completely dissolved within 5 minutes. The pH of the solution decreased to 4.7 and turned a green color. ICP measured the nickel concentration to be 524 ppm. Then 1.934 grams of 35% hydrazine (55% hydrazine hydrate) was added to 424.5 grams of the 11.0 ppg CaCl₂ containing nickel solution and a purple fine solid precipitated. The pH of the fluid increased to 7.8. The fluid was allowed to remain quiescent for 24 hours. At 24 hours the solution was filtered through medium DE and the nickel concentration in the filtrate was measured to be 1.3 ppm using ICP.

### Hypothetical Example 9

EDA is selected for testing as a complexing agent with a brine having a comparatively high concentration of zinc. The EDA is admixed with brine but does not preferentially bind with the zinc to form an insoluble complex. The EDA complexing agent is not selected for use with this particular brine.

### Hypothetical Example 10

DETA is selected for testing as a complexing agent with a brine having a comparatively high concentration of zinc. The DETA is admixed with brine and does preferentially bind with the zinc to form an insoluble complex. The insoluble complex is tested and found to be too fine to filter. The DETA complexing agent is not selected for use with this particular brine.

### Hypothetical Example 11

TETA is selected for testing as a complexing agent with a brine having a comparatively high concentration of zinc. The TETA is admixed with brine and does preferentially bind with the zinc to form an insoluble complex. The insoluble complex is tested and found to be readily removable by filtration. The TETA complexing agent is selected for use with this particular brine.

### Comments Regarding Certain Examples

According to the amount hydrazine added in Example 6, the amount of moles of hydrazine to react with the zinc is much closer to 1 to 1 whereas in Example 2 the ratio was 1 mole of hydrazine to 2 moles of zinc. The difference is that the fluid in Example 2 did not have any chlorides. Therefore, the precipitant can be a variety of zinc hydrazine complexes like Zn(N₂H₄)₂Br₂ or Zn(N₂H₄)Cl₂.

What is claimed is:

1. A method for recovering zinc metal, nickel metal, iron metal, zinc cations, nickel cations or iron cations from fluids produced from an oil well, the method comprising admixing an aqueous fluid produced from an oil well with hydrazine under conditions sufficient to produce an insoluble zinc or nickel hydrazine complex and removing the insoluble zinc or nickel hydrazine complex from the fluid.

2. The method of claim 1 wherein the hydrazine is employed as an aqueous solution having a hydrazine concentration of from about 10% to about 50%.

3. The method of claim 2 wherein the hydrazine is employed as an aqueous solution having a hydrazine concentration of from about 20% to about 40%.

4. The method of claim 3 wherein the hydrazine is employed as an aqueous solution having a hydrazine concentration of about 35%.

5. The method of claim 1 wherein the molar ratios of hydrazine to zinc, nickel, or iron necessary to form an insoluble complex is from about one to about three moles of hydrazine to about one mole of zinc, nickel, or iron.

6. The method of claim 5 wherein the molar ratios of hydrazine to zinc, nickel, or iron necessary to form an insoluble complex is from about one to about two moles of hydrazine to about one mole of zinc, nickel, or iron.

7. The method of claim 1 wherein the insoluble zinc, nickel, or iron hydrazine complex is removed from the fluid by filtering.

8. The method of claim 1 wherein the insoluble zinc, nickel, or iron hydrazine complex is removed from the fluid by centrifugation.

9. The method of claim 1 wherein the insoluble zinc, nickel, or iron hydrazine complex is removed from the fluid by settling.

10. The method of claim 1 wherein a fluid including the insoluble zinc, nickel, or iron hydrazine complex is first subjected to flocculation/coagulation prior to the insoluble zinc, nickel, or iron hydrazine complex being removed from the fluid.

11. The method of claim 10 wherein an additive selected from the group consisting of nonionic, cationic, and anionic polymers; lime; alum; ferric sulfate; and mixtures thereof is employed to effect the flocculation/coagulation.

12. The method of claim 1 further comprising recycling a fluid remaining after removal of the insoluble zinc, nickel, or iron hydrazine complex.

13. The method of claim 11 wherein the fluid being recycled is used to make new brine.

14. The method of claim 1 wherein the insoluble zinc, nickel, or iron hydrazine complex is recycled.

15. A method for removing zinc metal and/or zinc cations, anions, or salts from fluids produced from an oil well, the method comprising:
admixing a portion of an aqueous fluid produced from an oil well with a non-hydrazine complexing agent under conditions sufficient to produce an insoluble zinc complex;
evaluating the results of the admixing for formation of a readily removable zinc complex;
upon making a determination that the insoluble zinc complex has formed and is readily removable from the fluid, admixing some or all of the remaining aqueous fluid with the non-hydrazine complex under conditions sufficient to produce an insoluble zinc complex; and
removing the insoluble zinc complex from the aqueous fluid.

16. The method of claim 15 wherein the nonhydrazine complexing agent is selected from the group consisting of monodentate, bidentate, or poly dentate amine compounds; amino-ether, amino-alcohol, amino-ketone, and phosphorous analogs; and combinations thereof.

17. The method of claim 16 wherein the monodentate, bidentate, or poly dentate amine compounds are selected from the group consisting of ethylenediamine (EDA), diethylenetriamine (DETA), trithethylenetetramine (TETA), tetraethylenepentamine (TEPA), Aminoethylethanolamine (AEEA), diethanol amine (DEA), diethyl amine, hexamethyltetraamine, monoethyl amine, poly amines, and mixtures thereof.

18. The method of claim 15 further comprising immobilizing the non-hydrazine complexing compound onto a substrate.

19. The method of claim 18 wherein the substrate is selected from the group consisting of: nanoparticles, zeolites, polymer chains, solid substrates, nanotubes, and mixtures thereof.

20. The method of claim 15 wherein a fluid including the insoluble zinc nonhydrazine complex is first subjected to flocculation/coagulation prior to the zinc nonhydrazine complex being removed from the fluid.

21. A method for rehabilitating an aqueous fluid intended for use downhole comprising admixing an aqueous fluid with hydrazine under conditions sufficient to produce an insoluble zinc hydrazine complex and removing the insoluble zinc hydrazine complex from the fluid;
wherein the aqueous fluid is intended for use downhole in an oil well and the aqueous fluid has been contaminated with zinc.

22. A method for rehabilitating an aqueous fluid intended for use downhole comprising:
admixing a portion of an aqueous fluid intended for use downhole in an oil well with a non-hydrazine complexing agent under conditions sufficient to produce an insoluble zinc complex;
evaluating the results of the admixing for formation of a readily removable zinc complex;
upon making a determination that the insoluble zinc complex has formed and is readily removable from the fluid, admixing some or all of the remaining aqueous fluid with the non-hydrazine complex under conditions sufficient to produce an insoluble zinc complex; and
removing the insoluble zinc complex from the aqueous fluid;
wherein the aqueous fluid is intended for use downhole in an oil well and the aqueous fluid has been contaminated with zinc.
